(19) United States
(12) Patent Application Publication
(10) Pub. No.: US 2019/0059060 A1
(43) Pub. Date: Feb. 21, 2019

(54) INPUT POWER BACKOFF SIGNALING

(71) Applicant: QUALCOMM Incorporated, San Diego, CA (US)

(72) Inventors: Jialing Li Chen, San Diego, CA (US); Lin Yang, San Diego, CA (US); Bin Tian, San Diego, CA (US)

(21) Appl. No.: 16/040,367

(22) Filed: Jul. 19, 2018

Related U.S. Application Data
(60) Provisional application No. 62/546,502, filed on Aug. 16, 2017.

(51) Int. Cl. H04W 52/32; H04W 52/36; H04W 52/50

(52) U.S. Cl. CPC H04W 52/325; H04W 52/50; H04W 52/367; H04W 52/365

(57) ABSTRACT

This disclosure provides systems, methods and apparatuses for determining input power backoff (IBO) settings used to transmit wireless signals. In some implementations, a first wireless device may negotiate a mutually compatible set of IBO settings with a second wireless device, may receive a wireless signal from the second wireless device, and may determine the actual IBO value used by the second wireless device to transmit the wireless signal based at least in part on the negotiated set of IBO settings. The first wireless device may also receive an indication of the changed set of IBO settings from the second wireless device, and may update the set of IBO settings stored in the first wireless device based on the received indication.

### CROSS-REFERENCE TO RELATED APPLICATIONS

This patent application claims priority under 35 USC § 119(e) to U.S. Provisional Patent Application No. 62/546,502 entitled “INPUT POWER BACKOFF SIGNALING” filed on Aug. 16, 2017, the entirety which is incorporated by reference herein.

### TECHNICAL FIELD

The present disclosure relates generally to wireless communication systems, and specifically to input power backoff (IBO) for wireless communications.

### DESCRIPTION OF THE RELATED TECHNOLOGY

A wireless local area network (WLAN) may be formed by one or more access points (APs) that provide a shared wireless medium for use by a number of wireless devices or stations (STAs). Each AP, which may correspond to a Basic Service Set (BSS), periodically broadcasts beacon frames to enable any STAs within wireless range of the AP to establish and maintain a communication link with the WLAN. Wireless networks that operate in accordance with the IEEE 802.11 family of standards may be referred to as Wi-Fi networks, and wireless devices that transmit signals according to communication protocols specified by the IEEE 802.11 family of standards may be referred to as Wi-Fi devices.

The wireless range of a wireless device may be related to its transmission power level. For example, wireless signals transmitted at higher power levels typically travel farther than wireless signals transmitted at lower power levels. Many governmental regulations impose a power spectral density limit on the transmission power of wireless devices. Power spectral density limits may restrict the total transmit power, as well as the energy of out-of-band transmissions, of wireless devices. A transmitting device may use a relatively low transmit power level to minimize signal distortion caused by its power amplifiers, for example, so that a receiving device is able to receive and successfully decode information modulated onto the transmitted wireless signal. A transmitting device may maintain its transmit power at a level that ensures its power amplifiers mostly operate in the linear region, for example, to minimize signal distortion. Many wireless devices may comply with applicable power spectral density limits while minimizing signal distortion by using input power backoff (IBO) techniques.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method of determining input power backoff (IBO) values used for wireless transmissions between a first wireless device and a second wireless device. In some implementations, the method is performed by the first wireless device and may include negotiating a set of IBO values that are mutually compatible to each of the first and second wireless devices, receiving a wireless signal from the second wireless device, and determining an actual IBO value used by the second wireless device to transmit the wireless signal based at least in part on the negotiated set of IBO values. The method may also include receiving an indication of a change in the negotiated set of IBO values from the second wireless device, and updating the negotiated set of IBO values stored in the first wireless device based on the received indication.

In some implementations, the set of IBO values may be negotiated during at least one of an association operation, a negotiation operation, or an exchange of proposed sets of IBO values between the first and second wireless devices. In other implementations, the first wireless device may negotiate the set of IBO values by transmitting, to the second wireless device, a request including a first proposed set of IBO values, receiving, from the second wireless device, a reply including a second proposed set of IBO values, and determining the negotiated set of IBO values based on a combination of the first and second proposed sets of IBO values.

In some implementations, the first wireless device may estimate the actual IBO value used to transmit the wireless signal based on one or more of an indicated IBO value, the negotiated set of IBO values, and an output power backoff (OBO) value associated with transmission of the wireless signal. In addition, or in the alternative, the first wireless device may estimate the actual IBO value used by the second wireless device to transmit the wireless signal based on one or more of digital pre-distortion (DPD) settings of the second wireless device, power amplifier (PA) settings of the second wireless device, and an estimated OBO value associated with transmission of the wireless signal. In addition, or in the alternative, the first wireless device may estimate the actual IBO value used by the second wireless device to transmit the wireless signal based on an IBO value associated with a null data packet (NDP) containing one or more training symbols transmitted by the second wireless device, an estimated output power back-off (OBO) value of the NDP, and an estimated OBO value of the wireless signal.

Another innovative aspect of the subject matter described in this disclosure can be implemented in a first wireless device configured to determine input power backoff (IBO) values used for wireless transmissions by a second wireless device. In some implementations, the first wireless device can include one or more processors and a memory storing instructions. Execution of the instructions can cause the first wireless device to negotiate a set of IBO values that are mutually compatible to each of the first and second wireless devices, receive a wireless signal from the second wireless device, and determine an actual IBO value used by the second wireless device to transmit the wireless signal based at least in part on the negotiated set of IBO values. In some implementations, execution of the instructions can also cause the first wireless device to receive an indication of a change in the negotiated set of IBO values from the second wireless device, and to update the negotiated set of IBO values stored in the first wireless device based on the received indication.

Another innovative aspect of the subject matter described in this disclosure can be implemented in a non-transitory computer-readable medium. The non-transitory computer-readable medium can store instructions that, when executed by one or more processors of a first wireless device, cause the first wireless device to determine input power backoff (IBO) values used for wireless transmissions from a second wireless device by performing a number of operations. In some implementations, the number of operations can include negotiating a set of IBO values that are mutually compatible to each of the first and second wireless devices, receiving a wireless signal from the second wireless device, and determining an actual IBO value used by the second wireless device to transmit the wireless signal based at least in part on the negotiated set of IBO values. The number of operations can also include receiving an indication of a change in the negotiated set of IBO values from the second wireless device, and updating the negotiated set of IBO values stored in the first wireless device based on the received indication.

Another innovative aspect of the subject matter described in this disclosure can be implemented in an apparatus configured to determine input power backoff (IBO) values used for wireless transmissions by a wireless device. The apparatus can include means for negotiating a set of IBO values that are mutually compatible to each of the apparatus and the first wireless device, means for receiving a wireless signal from the wireless device, and means for determining an actual IBO value used by the wireless device to transmit the wireless signal based at least in part on the negotiated set of IBO values. In some implementations, the apparatus can also include means for receiving an indication of a change in the negotiated set of IBO values from the wireless device, and means for updating the negotiated set of IBO values stored in the apparatus based on the received indication.

### BRIEF DESCRIPTION OF THE DRAWINGS

FIG. 1 shows a block diagram of a wireless system.

FIGS. 2A-2C show block diagrams of an example transceiver.

FIG. 3 shows a block diagram of an example wireless station (STA).

FIG. 4 shows a block diagram of an example access point (AP).

FIG. 5A shows a graph depicting an example relationship between constellation points and operating regions of a power amplifier.

FIG. 5B shows a graph depicting another example relationship between constellation points and operating regions of a power amplifier.

FIG. 5C shows a graph depicting another example relationship between constellation points and operating regions of a power amplifier.

FIG. 6A shows an illustrative flow chart depicting an example operation for determining input power backoff (IBO) values used for wireless signal transmissions.

FIG. 6B shows an illustrative flow chart depicting an example operation for negotiating a set of IBO values between wireless devices.

FIG. 6C shows an illustrative chart depicting a number of operations for estimating the actual IBO value used for wireless signal transmissions.

FIG. 6D shows an illustrative flow chart depicting an example operation for updating input power backoff (IBO) values used for wireless signal transmissions.

FIG. 7 shows an illustrative flow chart depicting an example operation for updating a negotiated set of input power backoff (IBO) values used for wireless signal transmissions.

Like numbers reference like elements throughout the drawings and specification.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 802.11 specifications, or any of the IEEE 802.15 specifications, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example implementations. However, it will be apparent to one skilled in the art that these specific details may not be required to practice the example implementations. In other instances, well-known circuits and devices are shown in block diagram form to avoid obscuring the present disclosure.

A transmitting device may use an input power backoff (IBO) technique to comply with applicable power spectral density limits while minimizing signal distortion caused by power amplifiers in their transmitters. As used herein, input power backoff (IBO) may refer to a level or amount of power backoff applied to input signals of the power amplifiers. Selecting an IBO value that is too high (which may reduce the power level of the power amplifier's input signals by a relatively large amount) may result in lower peak throughput, shorter range, and lower power efficiency. Selecting an IBO value that is too low (which may reduce the power level of the power amplifier's input signals by a relatively small amount) may result in signal distortion and violation of applicable power spectral density limits. Thus, it is important to select an IBO value that achieves an optimum balance between wireless transmission range and signal distortion while also complying with applicable power spectral density limits.

Different receiving devices may have different decoding capabilities in the presence of signal distortion and interference. For example, while one receiving device may be able to successfully decode modulated information from wireless signals only if the signal distortion is below a level, another receiving device may be able to successfully decode modulated information from wireless signals when signal distortion is greater than that level. Thus, it is desirable for a transmitting device and a receiving device to negotiate and mutually agree on a set of IBO values for data transmissions between the transmitting device and the receiving device.

Aspects of the present disclosure may allow a transmitting device and a receiving device to determine or negotiate a set of mutually compatible IBO values for transmitting wireless signals to each other, and may also allow the receiving device to determine the actual IBO value used by the transmitting device to transmit wireless signals to the receiving device. In some implementations, the transmitting device and the receiving device may exchange IBO values and capabilities, may agree on a set of mutually compatible IBO values for exchanging wireless signals with each other, and may determine the actual IBO value used for the transmission of wireless signals from the other device. In this manner, aspects of the present disclosure may allow the transmitting device to increase its transmit power as long as (1) the transmitting device complies with applicable power spectral density limits and (2) the receiving device can continue decoding modulated information from wireless signals received from the transmitting device as levels of signal distortion increase due to greater transmit power levels.

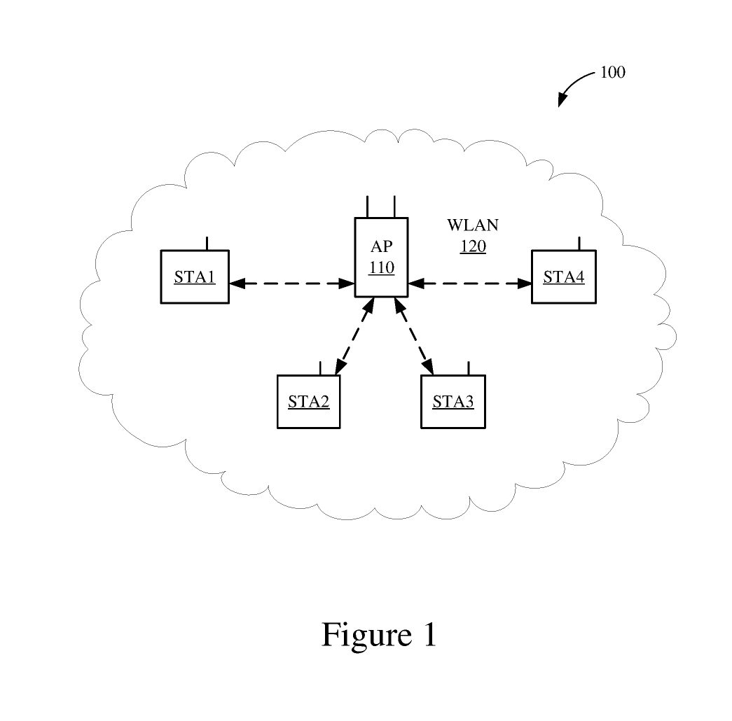

FIG. 1 shows a block diagram of an example wireless system 100. The wireless system 100 is shown to include four wireless stations STA1-STA4, a wireless access point (AP) 110, and a wireless local area network (WLAN) 120. The WLAN 120 may be formed by a plurality of access points (APs) that may operate according to the IEEE 802.11 family of specifications (or according to other suitable wireless protocols). Thus, although only one AP 110 is shown in FIG. 1 for simplicity, it is to be understood that WLAN 120 may be formed by any number of access points such as AP 110. The AP 110 may be assigned a unique MAC address that is programmed therein by, for example, the manufacturer of the access point. Similarly, each of the stations STA1-STA4 also may be assigned a unique MAC address. Although not specifically shown in FIG. 1, for at least some implementations, the stations STA1-STA4 may exchange signals directly with each other (such as without the presence of the AP 110).

In some implementations, the wireless system 100 may correspond to a multiple-input multiple-output (MIMO) wireless network, and may support single-user MIMO (SU-MIMO) and multi-user (MU-MIMO) communications. For other implementations, the wireless system 100 may correspond to or utilize orthogonal frequency division multiple access (OFDMA) communications. Further, although the WLAN 120 is depicted in FIG. 1 as an infrastructure Basic Service Set (BSS), for other implementations, WLAN 120 may be an Independent Basic Service Set (IBSS), an Extended Service Set (ESS), an ad-hoc network, or a peer-to-peer (P2P) network (such as operating according to Wi-Fi Direct protocols).

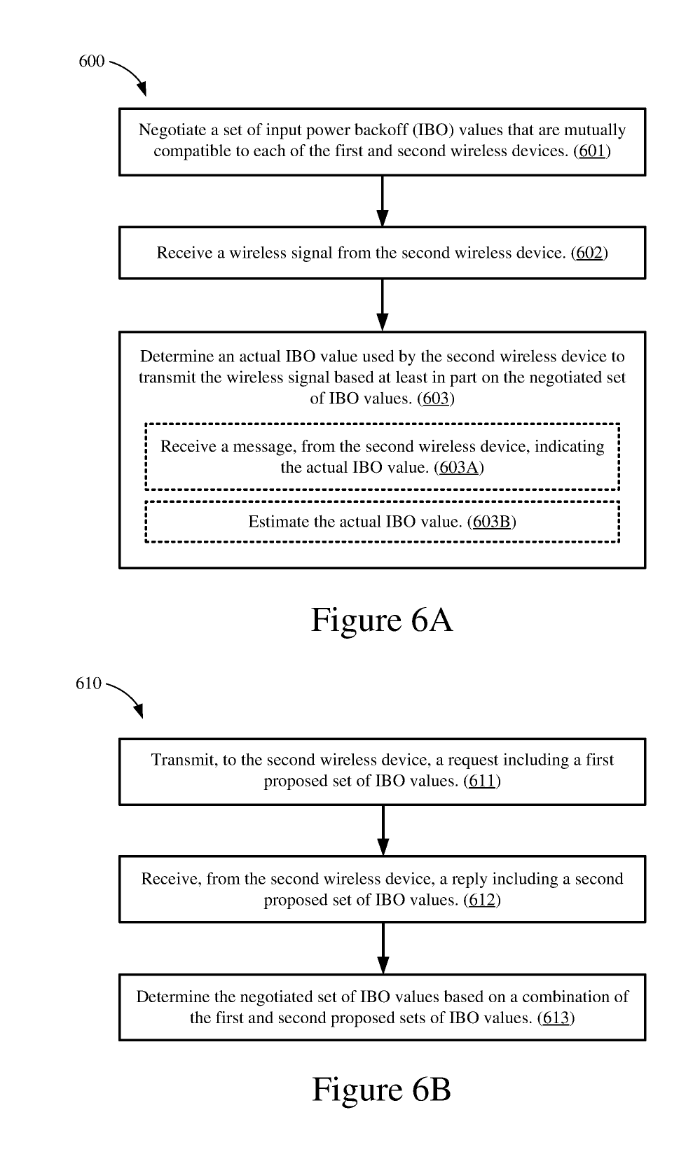

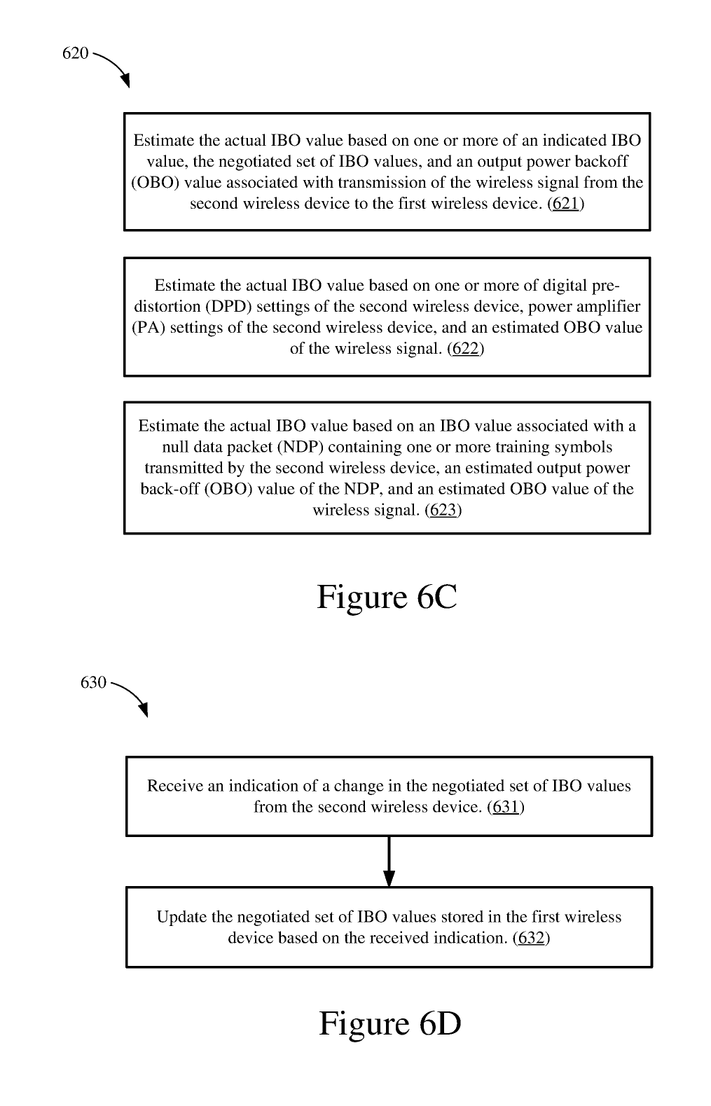

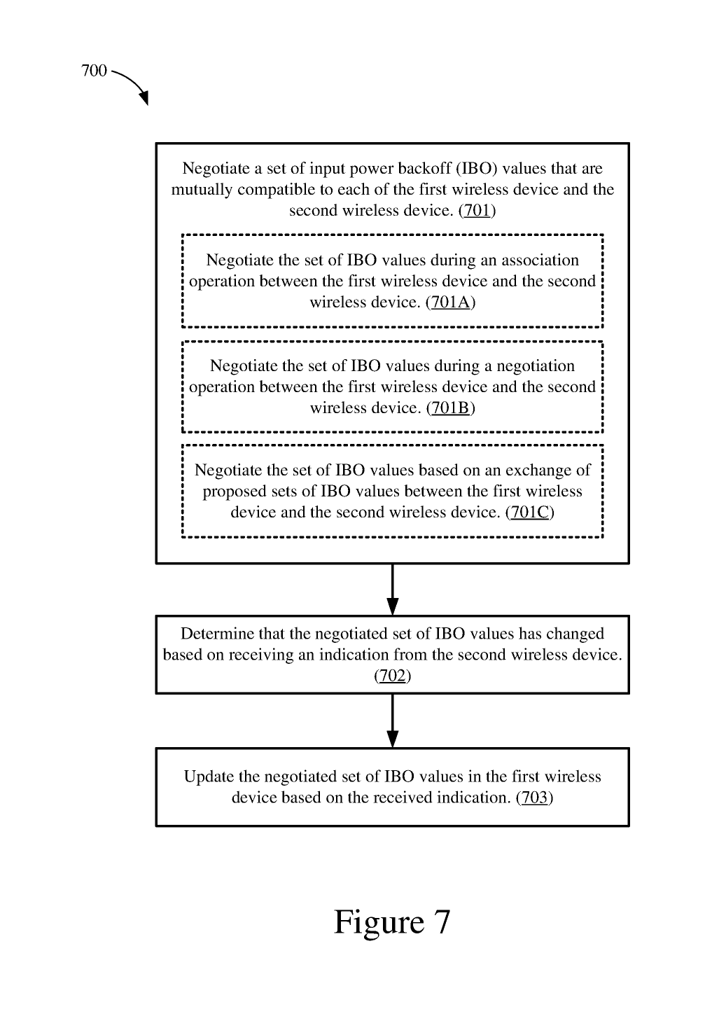

The stations STA1-STA4 may be any suitable Wi-Fi enabled wireless devices including, for example, cell phones, personal digital assistants (PDAs), tablet devices, laptop computers, or the like. The stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below with respect to FIGS. 6A-6D and FIG. 7.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below with respect to FIGS. 6A-6D and FIG. 7. For other implementations, one or more functions of AP 110 may be performed by one of stations STA1-STA4 (such as operating as a soft AP).

For the stations STA1-STA4 and AP 110, the one or more transceivers may include Wi-Fi transceivers, Bluetooth transceivers, cellular transceivers, or other suitable radio frequency (RF) transceivers (not shown for simplicity) to transmit and receive wireless communication signals. Each transceiver may communicate with other wireless devices in distinct frequency bands or using distinct communication protocols. For example, the Wi-Fi transceiver may communicate within a 2.4 GHz frequency band, within a 5 GHz frequency band, or within a 60 GHz frequency band in accordance with the IEEE 802.11 family of specifications. The cellular transceiver may communicate within various RF frequency bands in accordance with the LTE protocol described by the 3rd Generation Partnership Project (3GPP) (such as between approximately 700 MHz and approximately 3.9 GHz) or in accordance with other cellular protocols (such as the GSM protocol). In some implementations, the transceivers included within the stations STA1-STA4 or the AP 110 may be any technically feasible transceiver such as a ZigBee transceiver described by a specification from the ZigBee Alliance, a WiGig transceiver, or a HomePlug transceiver described by a specification from the HomePlug Alliance.

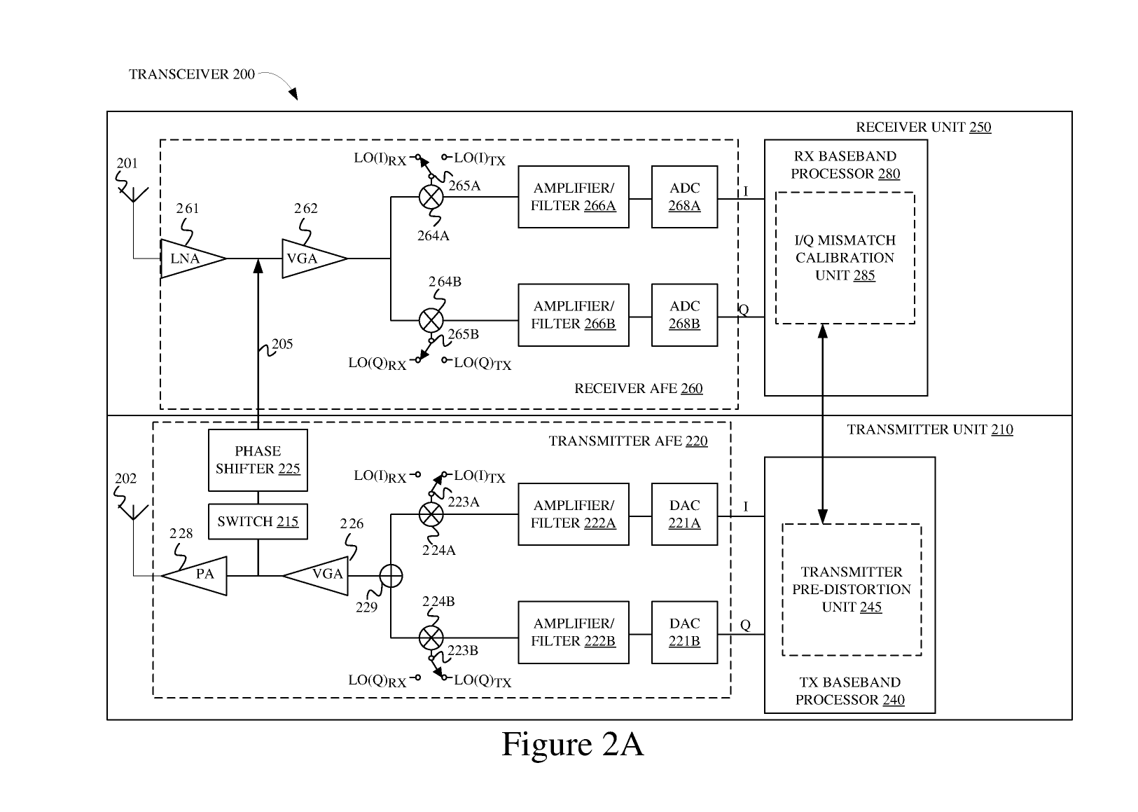

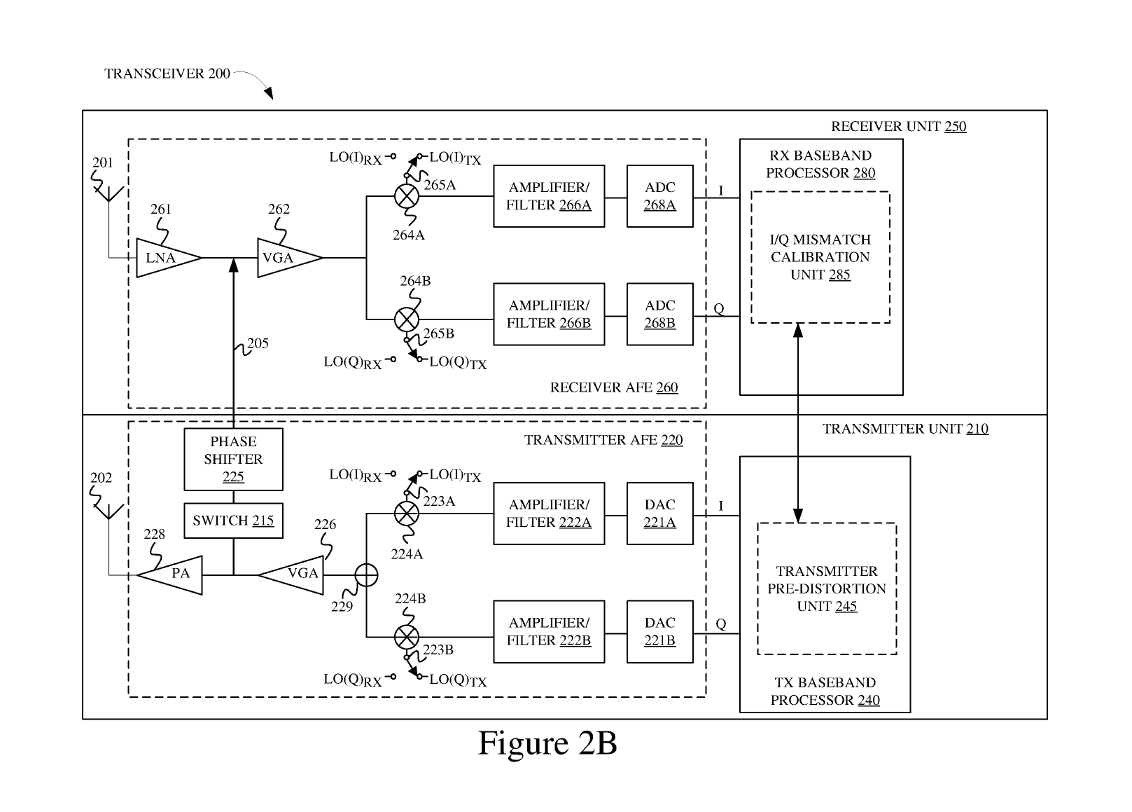

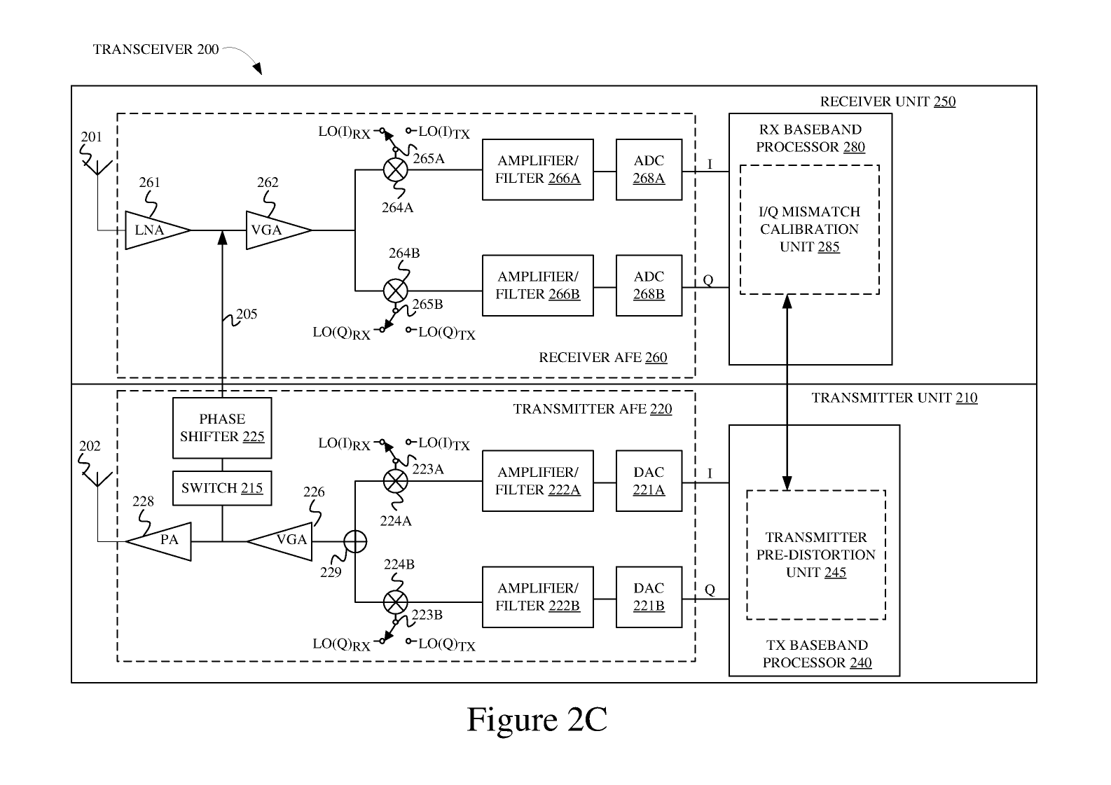

FIG. 2A is a block diagram of a frequency-division duplexing (1-DD) QAM transceiver 200. The transceiver 200 may be included within any suitable wireless communication device including, for example, the AP 110 of FIG. 1, the stations STA1-STA4 of FIG. 1, or both. The transceiver 200 includes a transmitter unit 210 and a receiver unit 250. A loop-back path 205 is coupled between the transmitter unit 210 and the receiver unit 250 in the analog front end (AFE) of the transceiver 200. The loop-back path 205 is located in a radio-frequency (RF) portion of the AFE. The loop-back path 205 may be used during calibration modes of the transceiver 200 to perform I/Q mismatch calibration operations. The calibration modes include a transmitter calibration mode for calibrating the transmitter unit 210 and a receiver calibration mode for calibrating the receiver unit 250.

In some implementations, the transmitter unit 210 includes a transmitter AFE 220 and a transmitter baseband processor 240. For wireless devices, the transmitter unit 210 also includes one or more antennas 202. The transmitter baseband processor 240 includes a transmitter pre-distortion unit 245. The receiver unit 250 includes a receiver AFE 260 and a receiver baseband processor 280. The receiver baseband processor 280 includes an I/Q mismatch calibration unit 285. For wireless devices, the receiver unit 250 also includes one or more antennas 201. Alternately, the transmitter unit 210 and receiver unit 250 share the same one or more antennas.

The transmitter AFE 220 includes a digital-to-analog converter (DAC) 221A for the in-phase (I) signal path, amplifier/filter circuitry 222A for the I signal path, a local oscillator (LO) mixer 224A for the I signal path, a DAC 221B for the quadrature (Q) signal path, amplifier/filter circuitry 222B for the Q signal path, an LO mixer 224B for the Q signal path, a variable gain amplifier (VGA) 226, and a power amplifier (PA) 228. The mixers 224A and 224B up-convert the I and Q transmit signals from baseband directly to the carrier frequency by mixing the I and Q transmit signals with local oscillator signals, where the frequency of the local oscillator signals is the carrier frequency. A combiner 229 combines the up-converted signals output from the mixers 224A and 224B to generate a QAM signal. The VGA 226 and the PA 228 amplify the QAM signal prior to transmission from antenna 202. Mismatch between the mixers 224A and 224B, mismatch between the amplifiers/filters 222A and 222B, and/or mismatch between the DACs 221A and 221B may result in transmitter-side I/Q mismatch.

The receiver AFE 260 includes a low-noise amplifier (LNA) 261, a VGA 262, an LO mixer 264A for the I signal path, amplifier/filter circuitry 266A for the I signal path, an analog-to-digital converter (ADC) 268A for the I signal path, an LO mixer 264B for the Q signal path, amplifier/filter circuitry 266B for the Q signal path, and an ADC 268B for the Q signal path. The mixers 264A and 264B directly down-convert the receive signal into baseband I and Q signals by mixing the receive signal with local oscillator signals, where the frequency of the local oscillator signals (as generated by a local oscillator, not shown) is ideally the carrier frequency. Mismatch between the mixers 264A and 264B, mismatch between the amplifiers/filters 266A and 266B, and/or mismatch between the between ADCs 268A and 268B may result in receiver-side I/Q mismatch.

The transceiver 200 of FIG. 2A is implemented as a direct-conversion transceiver that converts received wireless signals from a carrier frequency directly to baseband, and converts transmit signals directly from baseband to the carrier frequency. Other implementations are possible, however. For example, the receiver unit 250 and/or transmitter unit 210 may include additional mixers to implement an intermediate-frequency (IF) architecture. In some implementations, the receiver unit 210 may include an additional mixer after the VGA 262 to implement a sliding IF architecture. The additional mixer or mixers may be coupled to switches that are analogous to switches 223A-223B and switches 265A-265B.

During normal FDD operation, the receiver AFE 260 and the transmitter AFE 220 operate at distinct frequencies. In the receiver AFE 260, switches 265A and 265B are respectively coupled to mixers 264A and 264B and are configured in the normal operating mode to provide in-phase and quadrature receive local oscillator signals LO(I)_{RX} and LO(Q)_{RX} to mixers 264A and 264B. Local oscillator signals LO(I)_{RX} and LO(Q)_{RX} have a frequency corresponding to the carrier frequency of received signals. For example, the frequency of LO(I)_{RX} and LO(Q)_{RX} differs from the carrier frequency of received signals by a carrier frequency offset (CFO) that is a source of signal impairment. In the transmitter AFE 220, switches 223A and 223B are respectively coupled to mixers 224A and 224B and are configured in the normal operating mode to provide in-phase and quadrature transmit local oscillator signals LO(I)_{TX} and LO(Q)_{TX} to mixers 224A and 224B. The frequency of the local oscillator signals LO(I)_{TX} and LO(Q)_{TX} is the carrier frequency of the transmitted signals, and is distinct from the frequency of the local oscillator signals LO(I)_{RX} and LO(Q)_{RX}.

Each of the switches 265A, 265B, 223A, and 223B is configurable to provide either a transmit or a receive local oscillator signal to its corresponding mixer 264A, 264B, 224A, and 224B. For example, in a transmitter calibration mode, switches 265A and 223A are configured to provide LO(I)_{TX} to mixers 264A and 224A, and switches 265B and 223B are configured to provide LO(Q)_{TX} to mixers 264B and 224B, as shown in FIG. 2B. In a receiver calibration mode, switches 265A and 223A are configured to provide LO(I)_{RX} to mixers 264A and 224A, and switches 265B and 223B are configured to provide LO(Q)_{RX} to mixers 264B and 224B, as shown in FIG. 2C. The switches thus allow the transmitter unit 210 and receiver unit 250 to operate at the same frequency during calibration, thereby permitting the transceiver 200 to perform loop-back calibration.

In some implementations, a first end of the loop-back path 205 of the transmitter unit 210 is coupled between the VGA 226 and the PA 228 of the transmitter AFE 220, and in the receiver unit 250, a second end of the loop-back path 205 is coupled between the LNA 261 and the VGA 262 (such as shown in the examples of FIGS. 2A-2C). In other implementations, each of the ends of the loop-back path 205 may be coupled to different parts of the circuitry of the transmitter AFE 220 and the receiver AFE 260. For example, the first end of the loop-back path 205 may be coupled between the combiner 229 and the VGA 226 of the transmitter AFE 220, and the second end of the loop-back path 205 may be coupled between the VGA 262 and the LO mixers 264 of the receiver AFE 260.

The loop-back path 205 includes a loop-back switch 215 and a phase shifter 225, which may be part of or separate from the transmitter unit 210 or the receiver unit 250 portions of the transceiver 200. The loop-back switch 215 (such as a transistor) is used to open the loop-back path 205 during a normal mode of operation of the transceiver 200 (such as when transmitting and receiving RF signals via a network), and close the loop-back path 205 during calibration modes of operation. When closed, the loop-back path 205 couples the outputs of mixers 224A and 224B in the transmitter AFE 220 to inputs of the mixers 264A and 264B in the receiver AFE 260. In some implementations, the state of the loop-back switch 215 may be controlled by the I/Q mismatch calibration unit 285 of the receiver baseband processor 280. In other implementations, the loop-back switch 215 may be controlled by other device components (such as another controller implemented in hardware and/or software). The phase shifter 225 may be used during the calibration modes to add a phase shift to selected signals provided from the transmitter unit 210 to the receiver unit 250. In one example, the phase shifter 225 includes a phase shift element and a switch that is used to bypass the phase shift element.

During a calibration mode of operation, the loop-back switch 215 is closed, and the transmitter unit 210 may sequentially provide a first signal and a second signal to the receiver unit 250 via the loop-back path 205. In some implementations, the transmitter unit 210 provides the first signal to the receiver unit 250 without intentionally adding a phase shift, and intentionally adds a phase shift to the second signal provided to the receiver unit 250. For example, the switch of the phase shifter 225 may be closed to bypass the phase shift element during transmission of the first signal. After transmission of the first signal, the switch of the phase shifter 225 is opened, and the transmitter unit 210 provides a second signal to the receiver unit 250 with a phase shift added by the phase shift element. In some implementations, the switch of the phase shifter 225 may be opened and closed by the transmitter pre-distortion unit 245, the I/Q mismatch calibration unit 285, or another control entity of the transceiver 200.

During an I/Q mismatch calibration operation (such as transmitter calibration or receiver calibration), the receiver unit 250 determines a first set of I/Q measurements from the first signal and a second set of I/Q measurements from the second signal. For example, the receiver unit 250 determines measurements for both the I and Q components of the first signal, and measurements for both the I and Q components of the second signal with an added phase shift. The receiver unit 250 may calculate transmitter I/Q mismatch parameters and receiver I/Q mismatch parameters based on the first and second sets of I/Q measurements. For example, the receiver unit 250 may calculate the transmitter gain mismatch, the receiver gain mismatch, the transmitter phase mismatch, and the receiver phase mismatch. Depending on the calibration mode, the receiver unit 250 may provide the transmitter I/Q mismatch parameters to the transmitter unit 210. During transmitter calibration, for example, the I/Q mismatch calibration unit 285 may provide the calculated transmitter gain mismatch and transmitter phase mismatch to the transmitter pre-distortion unit 245, which may perform pre-distortion operations.

The components described with respect to the example transceiver 200 are merely illustrative. In various implementations, one or more of the components described herein may be omitted, combined, or modified, and additional components may be included. In some implementations, the transmitter unit 210 and receiver unit 250 may share antennas, or may have various additional antennas and transmitter/receiver chains. In other implementations, the transceiver 200 may include less or more filter and/or amplifier circuitry (such as blocks 222A-B and 266A-B of FIGS. 2A-2C). In some other implementations, the phase shift that is added to the second signal can be added by other techniques (such as by adding an offset to the phase of the local oscillator (LO) signals provided to the mixers 224A-224B).

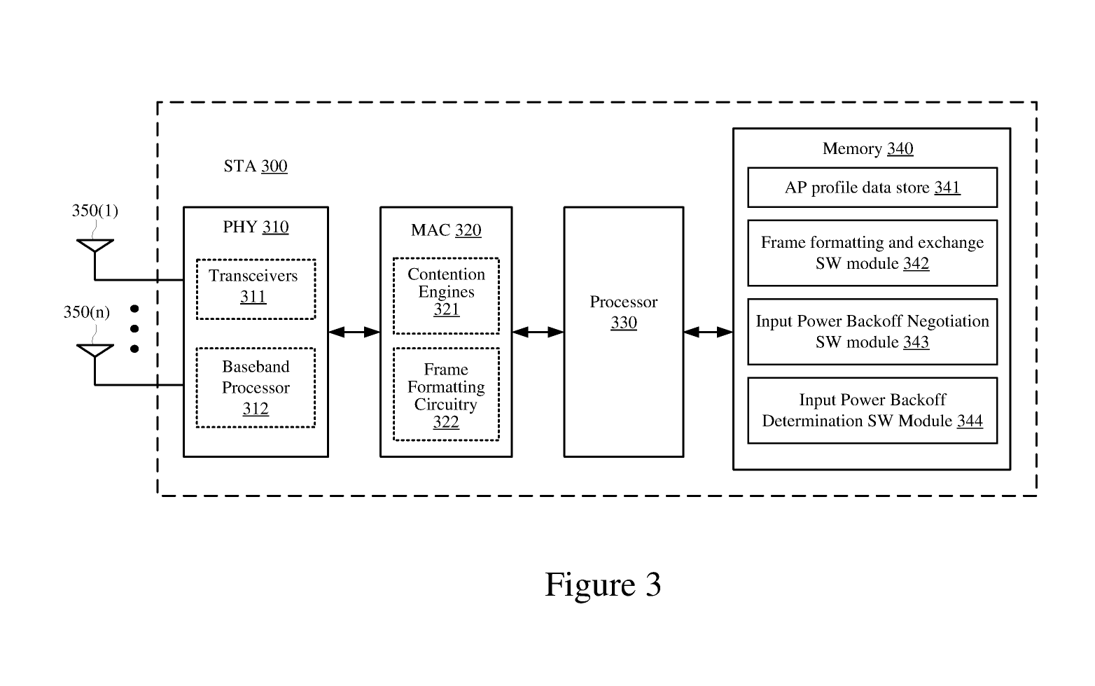

FIG. 3 shows an example STA 300. The STA 300 may be one implementation of one or more of the stations STA1-STA4 of FIG. 1. The STA 300 may include a physical layer device (PHY) 310, a MAC 320, a processor 330, a memory 340, and a number of antennas 350(1)-350(n). The PHY 310 may include at least a number of transceivers 311 and a baseband processor 312. The transceivers 311 may be coupled to antennas 350(1)-350(n), either directly or through an antenna selection circuit (not shown for simplicity). The transceivers 311 may be used to transmit signals to and receive signals from the AP 110 and other STAs (see also FIG. 1), and may be used to scan the surrounding environment to detect and identify nearby access points and/or other STAs (such as within wireless range of STA 300). Although not shown in FIG. 3 for simplicity, the transceivers 311 may include any number of transmit chains to process and transmit signals to other wireless devices via antennas 350(1)-350(n), and may include any number of receive chains to process signals received from antennas 350(1)-350(n). Thus, for example implementations, the STA 300 may be configured for multiple-input, multiple-output (MIMO) operations. The MIMO operations may include single-user MIMO (SU-MIMO) operations and multi-user MIMO (MU-MIMO) operations.

The baseband processor 312 may be used to process signals received from the processor 330 or the memory 340 (or both) and to forward the processed signals to the transceivers 311 for transmission via one or more of the antennas 350(1)-350(n), and may be used to process signals received from one or more of the antennas 350(1)-350(n) via the transceivers 311 and to forward the processed signals to the processor 330 or the memory 340 (or both).

The MAC 320 may include at least a number of contention engines 321 and frame formatting circuitry 322. The contention engines 321 may contend for access to one or more shared wireless mediums, and may also store packets for transmission over the one or more shared wireless mediums. The STA 300 may include one or more contention engines 321 for each of a plurality of different access categories. In other implementations, the contention engines 321 may be separate from MAC 320. In some other implementations, the contention engines 321 may be implemented as one or more software modules (such as stored in the memory 340 or stored in memory provided within the MAC 320) containing instructions that, when executed by processor 330, perform the functions of the contention engines 321.

The frame formatting circuitry 322 may be used to create or format (or both) frames received from the processor 330 (such as by adding MAC headers to PDUs provided by the processor 330), and may be used to re-format frames received from the PHY 310 (such as by stripping MAC headers from frames received from the PHY 310).

The memory 340 may include an AP profile data store 341 that stores profile information for a plurality of APs. The profile information for a particular AP may include information including, for example, the AP's service set identification (SSID), MAC address, channel information, received signal strength indicator (RSSI) values, goodput values, channel state information (CSI), supported data rates, supported channel access protocols, connection history with the AP, a trustworthiness value of the AP (such as indicating a level of confidence about the AP's location, etc.), supported input power backoff (IBO) values, and/or any other suitable information pertaining to or describing the operation of the AP.

The memory 340 may also include a non-transitory computer-readable medium (such as one or more nonvolatile memory elements, such as EPROM, EEPROM, Flash memory, a hard drive, and so on) that may store at least the following software (SW) modules:
a frame formatting and exchange software module 342 to create and exchange of any suitable frames (such as data frames, action frames, and management frames) between the STA 300 and other wireless devices, for example, as described for one or more operations of FIGS. 6A-6D and FIG. 7;
an input power backoff negotiation software module 343 to negotiate a set of IBO values that are mutually compatible to the STA 300 and one or more other wireless devices, for example, as described for one or more operations of FIGS. 6A-6D and FIG. 7; and
an input power backoff determination software module 344 to determine the actual IBO value used by a transmitting device to transmit a wireless signal to the STA 300, for example, as described for one or more operations of FIGS. 6A-6D and FIG. 7.

Each software module includes instructions that, when executed by the processor 330, cause the STA 300 to perform the corresponding functions. The non-transitory computer-readable medium of the memory 340 thus includes instructions for performing all or a portion of the operations depicted in FIGS. 6A-6D and FIG. 7.

The processor 330 may be any suitable one or more processors capable of executing scripts or instructions of one or more software programs stored in the STA 300 (such as within the memory 340). The processor 330 may execute the frame formatting and exchange software module 342 to create and exchange of any suitable frames (such as data frames, action frames, and management frames) between the STA 300 and other wireless devices. The processor 330 may execute the input power backoff negotiation software module 343 to negotiate a set of IBO values that are mutually compatible to the STA 300 and one or more other wireless devices. The negotiated set of IBO values may be used by the STA 300 and the other wireless devices when transmitting wireless signals to each other.

The processor 330 may execute the input power backoff determination software module 344 to determine the actual IBO value used by a transmitting device to transmit a wireless signal to the STA 300. In some implementations, the STA 300 may estimate the actual IBO value used by the transmitting device based on the set of negotiated IBO values, on an output power backoff (OBO) value associated with transmission of the wireless signal, or on a combination of both. In other implementations, the STA 300 may estimate the actual IBO value used by the transmitting device based on digital pre-distortion (DPD) settings of the transmitting device, on power amplifier (PA) settings of the transmitting device, on an estimated output power backoff (OBO) value used by the transmitting device, or any combination thereof.

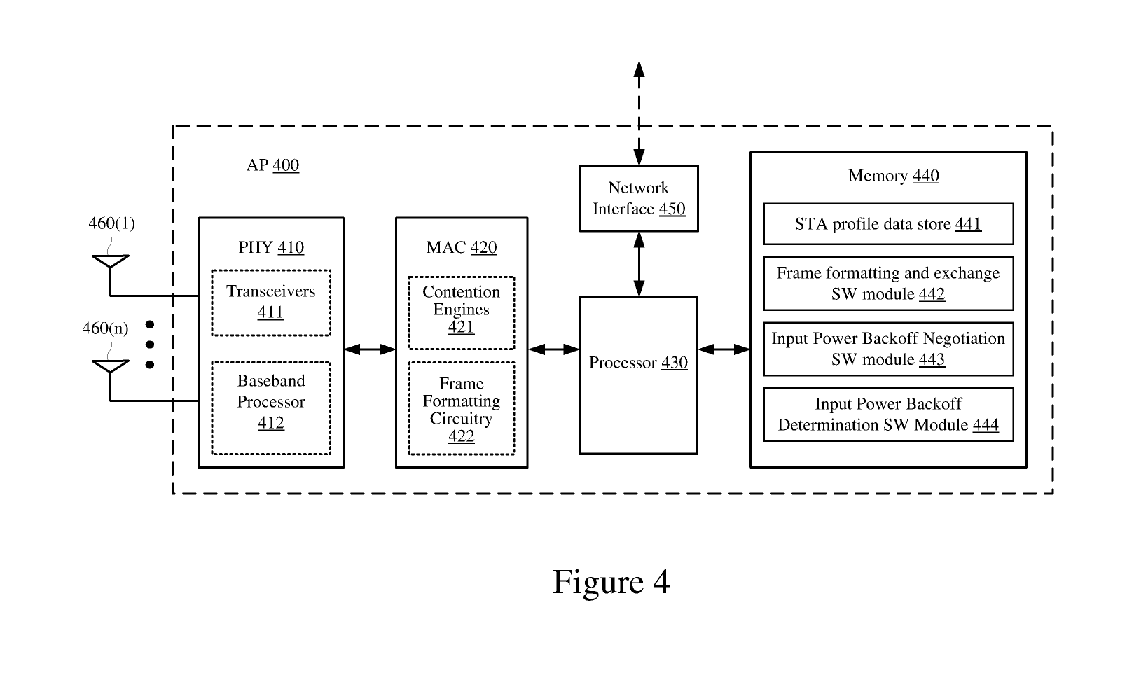

FIG. 4 shows an example access point (AP) 400. The AP 400, which may be one implementation of the AP 110 of FIG. 1, may include a PHY 410, a MAC 420, a processor 430, a memory 440, a network interface 450, and a number of antennas 460(1)-460(n). The PHY 410 includes at least a number of transceivers 411 and a baseband processor 412. The transceivers 411 may be coupled to the antennas 460(1)-460(n), either directly or through an antenna selection circuit (not shown for simplicity). The transceivers 411 may be used to communicate wirelessly with one or more STAs, with one or more other APs, with other suitable devices, or any combination thereof. Although not shown in FIG. 4 for simplicity, the transceivers 411 may include any number of transmit chains to process and transmit signals to other wireless devices via the antennas 460(1)-460(n), and may include any number of receive chains to process signals received from the antennas 460(1)-460(n). In some implementations, the AP 400 may be configured for MIMO operations including, for example, SU-MIMO operations and MU-MIMO operations.

The baseband processor 412 may be used to process signals received from the processor 430 or the memory 440 (or both) and to forward the processed signals to the transceivers 411 for transmission via one or more of the antennas 460(1)-460(n), and may be used to process signals received from one or more of the antennas 460(1)-460(n) via the transceivers 411 and to forward the processed signals to the processor 430 or the memory 440 (or both).

The network interface 450 may be used to communicate with a WLAN server (not shown for simplicity) either directly or via one or more intervening networks and to transmit signals.

The MAC 410 may include at least a number of contention engines 421 and frame formatting circuitry 422. The contention engines 421 may contend for access to the shared wireless medium, and may also store packets for transmission over the shared wireless medium. In some implementations, the AP 400 may include one or more contention engines 421 for each of a plurality of different access categories. In other implementations, the contention engines 421 may be separate from the MAC 420. In some other implementations, the contention engines 421 may be implemented as one or more software modules (such as stored in the memory 440 or within memory provided within the MAC 420) containing instructions that, when executed by the processor 430, perform the functions of the contention engines 421.

The frame formatting circuitry 422 may be used to create or format (or both) frames received from the processor 430 (such as by adding MAC headers to PDUs provided by the processor 430), and may be used to re-format frames received from the PHY 410 (such as by stripping MAC headers from frames received from the PHY 410).

The memory 440 may include a STA profile data store 441 that stores profile information for a plurality of STAs. The profile information for a particular STA may include information including, for example, its MAC address, supported data rates, supported channel access protocols, connection history with the STA, supported input power backoff (IBO) values, and/or any other suitable information pertaining to or describing the operation of the STA.

The memory 440 may also include a non-transitory computer-readable medium (such as one or more nonvolatile memory elements, such as EPROM, EEPROM, Flash memory, a hard drive, and so on) that may store at least the following software (SW) modules:
a frame formatting and exchange software module 442 to create and exchange of any suitable frames (such as data frames, action frames, and management frames) between the AP 400 and other wireless devices, for example, as described for one or more operations of FIGS. 6A-6D and FIG. 7;
an input power backoff negotiation software module 443 to negotiate a set of IBO values that are mutually compatible to the AP 400 and one or more other wireless devices, for example, as described for one or more operations of FIGS. 6A-6D and FIG. 7; and
an input power backoff determination software module 444 to determine the actual IBO value used to transmit a wireless signal to the AP 400, for example, as described for one or more operations of FIGS. 6A-6D and FIG. 7.

Each software module includes instructions that, when executed by the processor 430, cause the AP 400 to perform the corresponding functions. The non-transitory computer-readable medium of the memory 440 thus includes instructions for performing all or a portion of the operations depicted in FIGS. 6A-6D and FIG. 7.

The processor 430 may be any suitable one or more processors capable of executing scripts or instructions of one or more software programs stored in the AP 400 (such as within the memory 440). The processor 430 may execute the frame formatting and exchange software module 442 to create and exchange of any suitable frames (such as data frames, action frames, and management frames) between the AP 400 and other wireless devices. The processor 430 may execute the input power backoff negotiation software module 443 to negotiate a set of IBO values that are mutually compatible to the AP 400 and one or more other wireless devices. The negotiated set of IBO values may be used by the AP 400 and the other wireless devices when transmitting wireless signals to each other.

The processor 430 may execute the input power backoff determination software module 444 to determine the actual IBO value used by a transmitting device to transmit a wireless signal to the AP 400. In some implementations, the AP 400 may estimate the actual IBO value used by the transmitting device based on the set of negotiated IBO values, on an output power backoff (OBO) value associated with transmission of the wireless signal, or on a combination of both. In other implementations, the AP 400 may estimate the actual IBO value used by the transmitting device based on digital pre-distortion (DPD) settings of the transmitting device, on power amplifier (PA) settings of the transmitting device, on an estimated output power backoff (OBO) value used by the transmitting device, or any combination thereof.

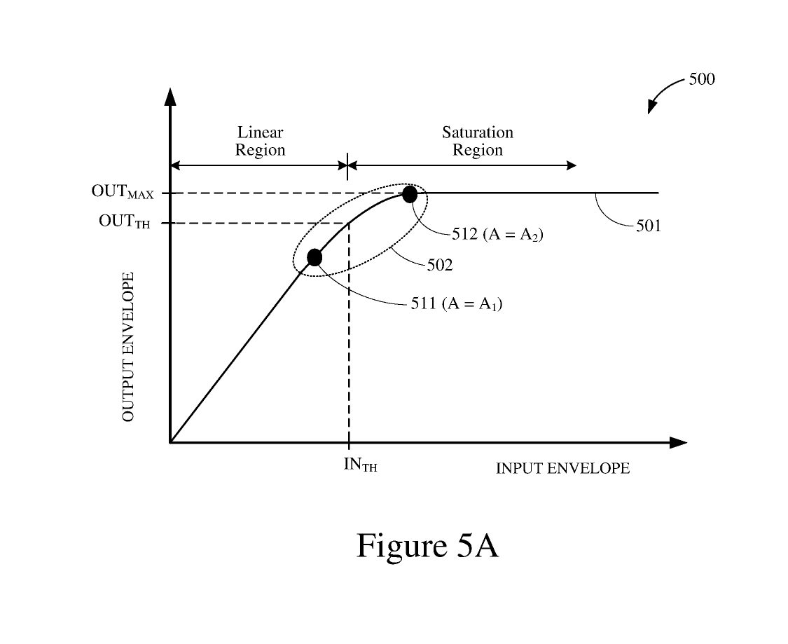

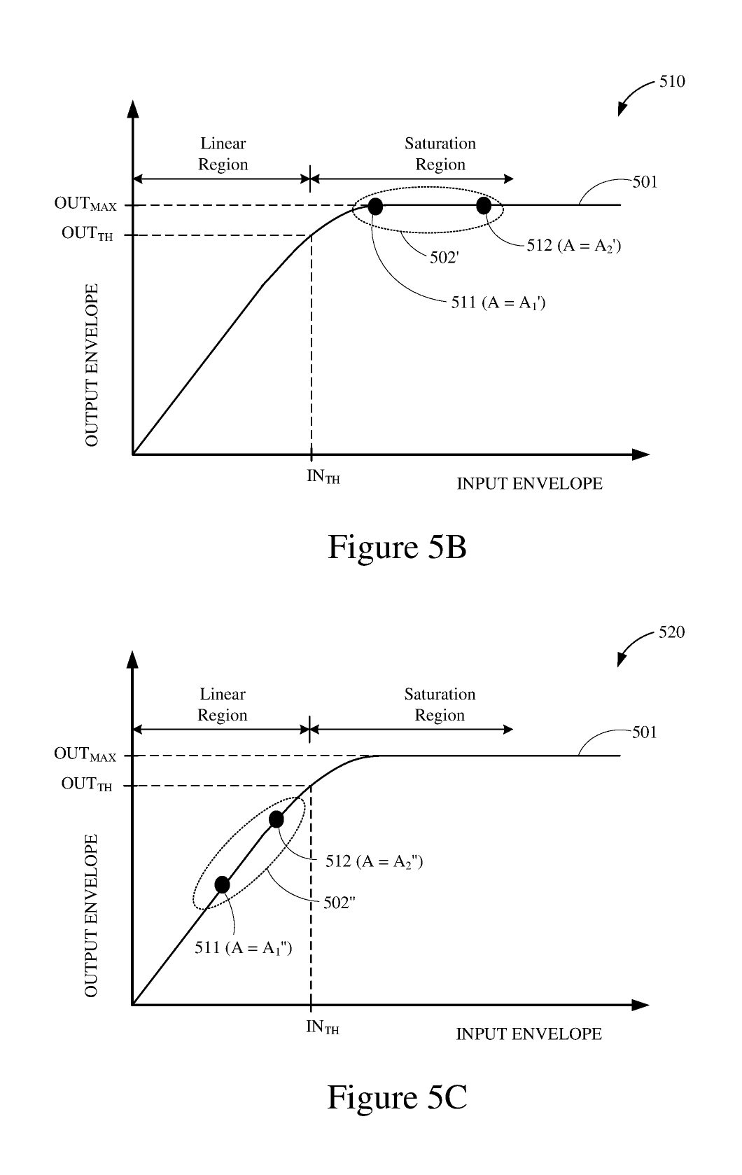

FIG. 5A shows a graph 500 depicting an example relationship between constellation points and operating regions of a power amplifier. The graph 500 is shown to include a curve 501 representing an output envelope (OUT) of a power amplifier (such the PA 228 of FIG. 2A) as a function of its input envelope (IN). The input envelope (IN) may represent any suitable input characteristics of signals to be amplified by the power amplifier, and the output envelope (OUT) may represent any suitable output characteristics of signals after amplification by the power amplifier. In some aspects, the input envelope (IN) may represent an input power level of signals provided to the power amplifier, and the output envelope (OUT) may represent an output power level of signals amplified by the power amplifier. In other aspects, the input envelope (IN) may represent an amplitude (such as input voltage) level of signals prior to amplification by the power amplifier, and the output envelope (OUT) may represent an amplitude (such as output voltage) level of signals after amplification by the power amplifier.

As depicted by curve 501, when the power amplifier operates in the linear region, the output envelope (OUT) is directly proportional to the input envelope (IN), and when the power amplifier operates in the saturation region, the output envelope (OUT) is no longer directly proportional to the input envelope (IN). More specifically, as long as the power amplifier operates in the linear region, the amplifier output signal's voltage may increase in a linear manner based on increases in the amplifier input signal's voltage. Conversely, when the power amplifier operates in the saturation region, the amplifier output signal's voltage does not increase beyond a maximum value (OUT_{MAX}), irrespective of further increases in the amplifier input signal's voltage (such as because the power amplifier is saturated). For illustrative purposes, the boundary between the liner region and the saturation region is depicted in FIG. 5 as corresponding to an input envelope threshold value (IN_{TH}) and to an output envelope threshold value (OUT_{TH}).

In some implementations, an operating region 502 of the power amplifier may be set so that a first amplitude value A=A₁ of QAM signals amplified by the power amplifier falls within the linear region of operation (such as A₁<IN_{TH}), and a second amplitude value A=A₂ of the QAM signals amplified by the power amplifier falls within the saturation region of operation (such as A₂>IN_{TH}). As a result, symbols mapped to first points 511 of a QAM constellation (corresponding to signal amplitudes A₁<IN_{TH}) may be amplified by the power amplifier in a linear manner, and symbols mapped to second points 512 of the QAM constellation (corresponding to signal amplitudes A₂>IN_{TH}) may be amplified by the power amplifier in a non-linear manner Thus, setting an operating point of the power amplifier to be within the operating region 502 of FIG. 5A may not only optimize (or maximize) the efficiency of the power amplifier, but may also ensure that symbols mapped to the first points 511 of the QAM constellation have less distortion than symbols mapped to second points 512 of the QAM constellation. In some aspects, the operating point of the power amplifier may be selected (or dynamically adjusted) to fall within the operating region 502 of FIG. 5A, for example, by selecting an appropriate IBO value for the amplification of signals to be transmitted to one or more other devices.

Setting the operating point of the power amplifier to other regions of curve 501 may degrade performance. For example, if the power amplifier is driven too hard (such that the QAM signals are amplified in a non-linear manner for both the first and second amplitude values A₁ and A₂ of the QAM signal), then symbols mapped to the first points 511 of the QAM constellation may have a similar amount of distortion as symbols mapped to the second points 512 of the QAM constellation.

FIG. 5B is a graph 510 depicting a power amplifier having an operating point within an operation region 502′ that lies entirely within the saturation region. When operating in operating region 502′ of FIG. 5B, the power amplifier amplifies QAM signals in a non-linear manner for both a first amplitude value A=A₁′ and a second amplitude value A=A₂′ of the QAM signal, which may cause significant distortion of symbols mapped to both the first points 511 of the QAM constellation and to symbols mapped to the second points 512 of the QAM constellation. As a result, a receiving device may not be able to distinguish between symbols mapped to points 511 and symbols mapped to points 512.

Conversely, if the power amplifier is not driven hard enough (such that the power amplifier always operates in the linear region, irrespective of the input signal amplitude), then the efficiency of the power amplifier may be too low to effectively transmit the wireless signals to the receiving device. FIG. 5C is a graph 520 depicting a power amplifier having an operating point within an operation region 502″ that lies entirely within the linear region. When operating in the operating region 502″ of FIG. 5C, the power amplifier amplifies QAM signals in a linear manner for both a first amplitude value A=A₁″ and a second amplitude value A=A₂″ of the QAM signals, and the efficiency of the power amplifier may fall below an acceptable level or threshold value associated with successful transmissions of the wireless signals to the receiving device.

Aspects of the present disclosure may allow a transmitting device and a receiving device to negotiate and agree on a set of supported IBO values that are mutually compatible to both the transmitting device and the receiving device, and to allow a receiving device to determine the actual IBO value that was used by the transmitting device to transmit a particular wireless signal to the receiving device. In some aspects, the IBO values supported by the transmitting device and the receiving device may be included in one or more wireless communications standards (such as the IEEE 802.11 family of standards), may be exchanged between the transmitting device and the receiving device, or both. Because different receiving devices may have different decoding capabilities in the presence of signal distortion, one or more of the IBO values used by the transmitting device may not be compatible with all receiving devices.

A number of constraints may limit the IBO values used by a transmitting device to a subset of the IBO values supported by the transmitting device. In some implementations, a transmitting device may need to comply with power spectral density limits for transmissions in a selected bandwidth or may use one or more transmission parameters associated with a selected transmission protocol (or both). For example, Wi-Fi devices are required by the Federal Communications Commission (FCC) to meet the spectral mask requirements provided in the 802.11 family of specifications, which limit transmit power in frequency bands adjacent to a carrier frequency of a transmitted signal (such as to minimize or reduce out-of-band transmissions). The transmission parameters may include one or more of a selected modulation and coding scheme (MCS), a selected set of MIMO settings (such as the number of transmitters (Ntx), the number of receivers (Nrx), and the number of spatial streams (Nss) used to transmit a wireless signal), beamforming settings, and a number of receiver parameters (such as a range of error vector magnitudes (EVMs) tolerable by the receiving device). Each set of MIMO settings may include one or both of SU-MIMO settings and MU-MIMO settings.

In some implementations, a transmitting device may store an IBO value for each unique combination of transmission parameters (such as transmit bandwidth, MIMO settings, and beamforming settings) in a look-up table (or some other suitable memory). In some aspects, the transmitting device may select the IBO value from the look-up table (LUT) based on the available channel bandwidth, the current MIMO settings, and the current beamforming settings. For one example, wireless transmissions using relatively large channel bandwidths (such as 80 MHz channels) are typically associated with higher IBO values than wireless transmissions using relatively small channel bandwidths (such as 20 MHz channels) because of masking requirements to limit out-of-band transmissions. For another example, higher-order MIMO transmissions (such as 4×4 MIMO transmissions) are typically associated with higher IBO values than lower-order MIMO transmissions (such as 2×4 MIMO transmissions) because signal distortion becomes greater as the number of spatial streams increases. For yet another example, because beamforming techniques typically reduce signal distortion, wireless signals transmitted using beamforming techniques may be associated with lower IBO values than wireless signals that are not transmitted using beamforming techniques.

In some implementations, the transmitting device may indicate the IBO value used for a given wireless transmission to the receiving device. The receiving device may use the indicated IBO value to estimate and compensate for signal distortion in one or more of its power amplifiers. In some aspects, the transmitting device may provide the look-up table containing the IBO value for each unique combination of transmission parameters to the receiving device. In some aspects, the lookup table may be included in one or more information elements (IEs) or vendor specific information elements (VSIEs) of a suitable frame or packet transmitted to the receiving device. In other aspects, the lookup table may be included in one or more capability fields or extended capability fields of a suitable frame or packet transmitted to the receiving device.

In some implementations, the transmitting device and the receiving device may exchange supported IBO values and compatibility information during association operations or during negotiation operations. In some aspects, the supported IBO values and compatibility information may be exchanged between the transmitting device and the receiving device using probe request and probe response frames. In other aspects, the supported IBO values and compatibility information may be exchanged between the transmitting device and the receiving device using beacon frames and response frames. In some other aspects, the supported IBO values and compatibility information may be exchanged between the transmitting device and the receiving device using any suitable frame or packet.

In some implementations, the transmitting device and the receiving device may negotiate a set of mutually compatible IBO values by exchanging proposed sets of IBO values and combining a number of the proposed sets of IBO values. For example, the transmitting device may initiate an IBO negotiation operation by sending a request with a first proposed set of IBO values to the receiving device. In some aspects, the request may include a lookup table containing proposed IBO values for each unique combination of transmission parameters. The request may be included in any suitable frame including, for example, a beacon frame, a response frame, a probe request frame, a probe response frame, a trigger frame, a management frame, or any other suitable frame.

The receiving device may reply with a second proposed set of IBO values. In some implementations, the second proposed set of IBO values may be based on a range of receiver-tolerable EVMs. The range of receiver-tolerable EVMs may be important because the receiving device may be capable of accurately detecting received packets in the presence of significant interference.

The transmitting device and the receiving device may select a set of mutually compatible IBO values based at least in part on the first and the second proposed sets of IBO values. In some implementations, the second proposed set of IBO values may include those IBO values of the first proposed set of IBO values which are mutually compatible with the receiving device. In other implementations, the set of mutually compatible IBO values may be based on a logical AND operation of the first and the second proposed sets of IBO values. One or more additional proposed sets of IBO values may be exchanged before the transmitting device and the receiving device agree on the set of mutually compatible IBO values.

As described above, the IBO value used by the transmitting device to transmit wireless signals may depend on one or more transmission parameters (such as the transmit bandwidth, the MIMO settings, and the beamforming settings) of the transmitting device. In some implementations, if one or more of the transmit bandwidth, the MIMO settings, and the beamforming settings of the transmitting device changes, then the transmitting device may select a new IBO value for wireless transmissions to the receiving device. In some aspects, the transmitting device may indicate the new IBO value to the receiving device by transmitting a frame containing the new IBO value to the receiving device. In other aspects, the transmitting device may request the receiving device to negotiate a number of new IBO values that are mutually compatible to the transmitting device and the receiving device. In other implementations, the transmitting device may update its set of proposed IBO values based on changes in one or more of the transmit bandwidth, the MIMO settings, and the beamforming settings, and may indicate the updated set of proposed IBO values to the receiving device. In some aspects, the transmitting device may indicate the updated set of proposed IBO values to the receiving device by transmitting a frame containing the updated set of proposed IBO values to the receiving device. In other aspects, the transmitting device may request the receiving device to negotiate a new set of mutually compatible IBO values that are based, at least in part, on the updated set of proposed IBO values.

In addition, or in the alternative, if the transmitting device changes or updates the MCS used to modulate data onto wireless signals transmitted to the receiving device, then the transmitting device may select a new set of IBO values that are mutually compatible with both devices. The new set of IBO values may correspond with the updated MCS used by the transmitting device. In some aspects, if the transmitting device detects an increase in packet error rates or begins to experience congestion on the wireless medium, the transmitting device may decrease the MCS used to modulate data on the wireless signals (such as to reduce signal distortion and thereby minimize packet error rates). For example, because wireless signals modulated using a relatively low MCS are less susceptible to signal distortion than wireless signals modulated using a relatively high MCS, the transmitting device may select a lower IBO value for wireless transmissions in response to decreases in the MCS. Conversely, if the transmitting device detects a decrease in packet error rates or determines that channel conditions are improving, the transmitting device may increase the MCS used to modulate data on the wireless signals (such as to increase wireless range and to increase data throughput). Because wireless signals modulated using a relatively high MCS are more susceptible to signal distortion than wireless signals modulated using a relatively low MCS, the transmitting device may select a higher IBO value for wireless transmissions in response to increases in the MCS.

In some implementations, the transmitting device may exchange or negotiate a new set of mutually compatible IBO values with the receiving device based on changes in the MCS used by the transmitting device. In some other implementations, the transmitting device may select a new set of proposed IBO values based on changes in the MCS used by the transmitting device, and may inform the receiving device of the new set of proposed IBO values.

The actual IBO value applied to the power amplifiers of the transmitting device during wireless transmissions may be different than (such as by an offset amount) the IBO value selected by the transmitting device, for example, due to imperfections in power control of analog circuits. Thus, although the receiving device may be informed of the IBO value selected by the transmitting device, the receiving device may not be aware of the amount of offset between the selected IBO value and the actual IBO value used by the transmitting device, and therefore may not know the actual IBO value used by the transmitting device to transmit the wireless signal. Because the reconstruction of signals received in error at the receiving device may be based on the actual IBO value used by the transmitting device, it is important for the receiving device to determine the actual IBO value used by the transmitting device (rather than the selected IBO value) to ensure accurate signal reconstruction. In some aspects, the receiving device may receive a portion of demodulated data from a wireless signal, and use the demodulated portion and the actual IBO value used by the transmitting device to recover or reconstruct other portions of the wireless signal.

In some implementations, the IBO value selected by the transmitting device may be indicated to the receiving device prior to transmission of a data packet, and the receiving device may estimate an output power backoff (OBO) value associated with the transmitted data packet. The receiving device may estimate the actual IBO value used by the transmitting device to transmit the data packet based on the estimated OBO value (and thereby also determining the offset between the selected IBO value of the transmitting device and the actual IBO value used by the transmitting device).

In addition, or in the alternative, the receiving device may determine the actual IBO value used by the transmitting device for transmitting wireless signals based at least in part on one or more digital pre-distortion (DPD) settings or power amplifier (PA) settings (or both) associated with the transmitting device, for example, when the transmitting device does not provide an indication of the selected IBO value used for wireless transmissions. In some implementations, if the DPD settings and the PA settings of the transmitting device are known to the receiving device, then the receiving device may measure the received power of the wireless signals and estimate the OBO value for the received signal based on the measured receive power, the DPD settings, and the PA setting. The receiving device may use the estimated OBO value to determine the actual IBO value used by the transmitting device to transmit the wireless signals. If the DPD settings and the PA settings are not known to the receiving device, then the receiving device may estimate an equivalent model for the DPD settings and the PA settings of the transmitting device, estimate the OBO value for the received signal based on the estimated equivalent model, and use the estimated OBO value to determine the actual IBO value used by the transmitting device.

In some implementations, the receiving device may estimate the DPD settings and the PA settings of the transmitting device based on a comparison of an estimated OBO value associated with the transmission of one or more training sequences and an estimated OBO value associated with the transmission of a data packet. The one or more training sequences are known to the receiving device, and thus may be used to determine back-off power levels associated with the transmission of known data sequences. The data packet typically has an unknown data sequence, and thus may be used to determine back-off power levels associated with the transmission of data.

In some implementations, the transmitting device may transmit a null data packet (NDP) containing one or more training sequences using a first IBO value. The receiving device may use the one or more known training sequences to estimate the actual IBO value used by the transmitting device to transmit the NDP, and may measure the output power of the received NDP to estimate an output power back-off (OBO) value associated with the NDP. The transmitting device may then transmit a data packet (with no training sequences) using a second IBO value that is different from the first IBO value. The receiving device may measure the output power of the received data packet to estimate an OBO value associated with the data packet, and may estimate the actual IBO value of the data packet based on the estimated IBO value of the NDP, the estimated OBO value of the NDP, and the estimated OBO value of the data packet. In some aspects, the receiving device may determine the difference between the estimated OBO value of the NDP and the estimated OBO value of the data packet, and then estimate the actual IBO value of the data packet by combining the difference with the estimated OBO value of the NDP. In other implementations, the receiving device may determine the difference between the estimated IBO value of the NDP (the first IBO value) and the estimated IBO value of the data packet (the second IBO value) based on an average power difference—such as an AGC gain difference—between the training packet and the data packet.

FIG. 6A shows an illustrative flow chart depicting an example operation 600 for determining input power backoff (IBO) values used for wireless signal transmissions. The operation 600 may be performed by or between any suitable wireless devices including, for example, any of the stations STA1-STA4 of FIG. 1, the AP 110 of FIG. 1, the STA 300 of FIG. 3, or the AP 400 of FIG. 4. For purposes of discussion herein, a first wireless device receives a wireless signal from a second wireless device, and determines the actual IBO value used by the second wireless device to transmit the wireless signal. In some implementations, the first wireless device may be a receiving device, and the second wireless device may be a transmitting device.

The first wireless device may negotiate a set of IBO values that are mutually compatible to each of the first and second wireless devices (601). In some implementations, the set of IBO values may be negotiated during at least one of an association operation, a negotiation operation, or an exchange of proposed sets of IBO values between the first and second wireless devices. For example, FIG. 6B shows an illustrative flow chart depicting an example operation 610 for negotiating a set of IBO values that are mutually compatible to each of the first and second wireless devices. The first wireless device may transmit, to the second wireless device, a request including a first proposed set of IBO values (611). In some implementations, the first proposed set of IBO values may be part of or included within one or more wireless communications standards (such as the IEEE 802.11 family of standards).

The first wireless device may receive, from the second wireless device, a reply including a second proposed set of IBO values (612). In some implementations, the second proposed set of IBO values may include those IBO values of the first proposed set of IBO values that are mutually compatible with each of the first and second wireless devices.

The first wireless device may determine the negotiated set of IBO values based on a combination of the first and second proposed set of IBO values (613). In other implementations, the set of mutually compatible IBO values may be based on a logical AND operation of the first and the second proposed sets of IBO values. One or more additional proposed sets of IBO values may be exchanged before the first and second wireless devices agree on the set of mutually compatible IBO values.

Referring again to FIG. 6A, the first wireless device may receive a wireless signal from the second wireless device (602), and may determine the actual IBO value used by the second wireless device to transmit the wireless signal based at least in part on the negotiated set of IBO values (603). In some implementations, the first wireless device may receive a message, from the second wireless device, indicating the actual IBO value (603A). In other implementations, the first wireless device may estimate the actual IBO value (603B). In some other implementations, the first wireless device may determine the actual IBO value using another suitable technique. As such, the sub-operations 603A and 603B depicted in FIG. 6A are illustrative examples of aspects of the present disclosure and are not to be interpreted as essential features of the example operation 600 of FIG. 6A.

For example, FIG. 6C shows an illustrative chart 620 depicting a number of operations for estimating the actual IBO value used by the second wireless device to transmit the wireless signal to the first wireless device. In some implementations, the first wireless device may estimate the actual IBO value used by the second wireless device based on one or more of an indicated IBO value, the negotiated set of IBO values, and an output power backoff (OBO) value associated with transmission of the wireless signal from the second wireless device to the first wireless device (621). In addition, or in the alternative, the first wireless device may estimate the actual IBO value used by the second wireless device based on digital pre-distortion (DPD) settings of the second wireless device, on power amplifier (PA) settings of the second wireless device, on an estimated OBO value of the wireless signal, or any combination thereof (622). In addition, or in the alternative, the first wireless device may estimate the actual IBO value used by the second wireless device based on an IBO value associated with a null data packet (NDP) containing one or more training symbols transmitted by the second wireless device, an estimated output power back-off (OBO) value of the NDP, and an estimated OBO value of the wireless signal (623).

FIG. 6D shows an illustrative flow chart depicting an example operation 630 for updating input power backoff (IBO) values used for wireless signal transmissions. The first wireless device may receive an indication of a change in the negotiated set of IBO values from the second wireless device (631). For example, because the negotiated set of mutually compatible IBO values may depend on a number of transmission parameters (such as channel bandwidth, MIMO settings, and beamforming settings), the negotiated set of IBO values may change when one or more of the transmission parameters changes. In some implementations, the second wireless device may determine that one or more of its transmission parameters have changed, and may update (such as by changing) its corresponding set of proposed IBO values based on the changes in transmission parameters. In some aspects, the second wireless device may inform the first wireless device of the updated set of proposed IBO values.

The first wireless device may update the negotiated set of IBO values stored in the first wireless device based on the received indication (632). In some implementations, the second wireless device may send the updated negotiated set of IBO values to the first wireless device. In some other implementations, the second wireless device may request the first wireless device to negotiate a new set of IBO values that are mutually compatible with each of the first and second wireless devices.

FIG. 7 is an illustrative flow chart showing an example operation 700 for determining input power backoff (IBO) values used by wireless devices. The operation 700 may be performed by or between any suitable wireless devices including, for example, any of the stations STA1-STA4 of FIG. 1, the AP 110 of FIG. 1, the STA 300 of FIG. 3, or the AP 400 of FIG. 4.

For the example operation 700 of FIG. 7, a first wireless device may negotiate a set of IBO values to be used for wireless communications with a second wireless device (701). In some aspects, the set of IBO values may be negotiated during an association operation between the first wireless device and the second wireless device (701A). In other aspects, the set of IBO values may be negotiated during a negotiation operation between the first wireless device and the second wireless device (701B). In some other aspects, the set of IBO values may be negotiated based on an exchange of proposed sets of IBO values between the first wireless device and the second wireless device (701C).

The first wireless device may determine that the negotiated set of IBO values has changed based on receiving an indication from the second wireless device (702), and may update the negotiated set of IBO values in the first wireless device based on the received indication (703).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of determining input power backoff (IBO) values used for wireless transmissions between a first wireless device and a second wireless device, the method performed by the first wireless device and comprising:
negotiating a set of IBO values that are mutually compatible to each of the first and second wireless devices;
receiving a wireless signal from the second wireless device; and
determining an actual IBO value used by the second wireless device to transmit the wireless signal based at least in part on the negotiated set of IBO values.

2. The method of claim 1, wherein the set of IBO values is negotiated during at least one of an association operation, a negotiation operation, or an exchange of proposed sets of IBO values between the first and second wireless devices.

3. The method of claim 1, further comprising:
receiving an indication of a change in the negotiated set of IBO values from the second wireless device; and
updating the negotiated set of IBO values stored in the first wireless device based on the received indication.

4. The method of claim 1, wherein determining the actual IBO value comprises:
receiving a message, from the second wireless device, indicating the actual IBO value.

5. The method of claim 1, wherein determining the actual IBO value comprises:
estimating the actual IBO value based on one or more of an indicated IBO value, the negotiated set of IBO values, and an output power backoff (OBO) value associated with transmission of the wireless signal.

6. The method of claim 1, wherein determining the actual IBO value comprises:
estimating the actual IBO value based on one or more of digital pre-distortion (DPD) settings of the second wireless device, power amplifier (PA) settings of the second wireless device, and an estimated output power backoff (OBO) value of the wireless signal.

7. The method of claim 1, wherein determining the actual IBO value comprises:
estimating the actual IBO value based on an IBO value associated with a null data packet (NDP) containing one or more training symbols transmitted by the second wireless device, an estimated output power back-off (OBO) value of the NDP, and an estimated OBO value of the wireless signal.

8. The method of claim 1, wherein negotiating the set of IBO values comprises:
transmitting, to the second wireless device, a request including a first proposed set of IBO values;
receiving, from the second wireless device, a reply including a second proposed set of IBO values; and
determining the negotiated set of IBO values based on a combination of the first and second proposed sets of IBO values.

9. The method of claim 8, wherein the second proposed set of IBO values is based on a range of receiver-tolerable error vector magnitudes (EVMs).

10. A first wireless device configured to determine input power backoff (IBO) values used for wireless transmissions by a second wireless device, the first wireless device comprising:
one or more processors; and
a memory storing instructions that, when executed by the one or more processors, cause the first wireless device to:
negotiate a set of IBO values that are mutually compatible to each of the first and second wireless devices;
receive a wireless signal from the second wireless device; and
determine an actual IBO value used by the second wireless device to transmit the wireless signal based at least in part on the negotiated set of IBO values.

11. The first wireless device of claim 10, wherein the set of IBO values is negotiated during at least one of an association operation, a negotiation operation, or an exchange of proposed sets of IBO values between the first and second wireless devices.

12. The first wireless device of claim 10, wherein execution of the instructions further causes the first wireless device to:
receive an indication of a change in the negotiated set of IBO values from the second wireless device; and
update the negotiated set of IBO values stored in the first wireless device based on the received indication.

13. The first wireless device of claim 10, wherein execution of the instructions to determine the actual IBO value causes the first wireless device to:
receive a message, from the second wireless device, indicating the actual IBO value.

14. The first wireless device of claim 10, wherein execution of the instructions to determine the actual IBO value causes the first wireless device to:
estimate the actual IBO value based on one or more of an indicated IBO value, the negotiated set of IBO values, and an output power backoff (OBO) value associated with transmission of the wireless signal.

15. The first wireless device of claim 10, wherein execution of the instructions to determine the actual IBO value causes the first wireless device to:
estimate the actual IBO value based on one or more of digital pre-distortion (DPD) settings of the second wireless device, power amplifier (PA) settings of the second wireless device, and an estimated output power backoff (OBO) value of the wireless signal.

16. The first wireless device of claim 10, wherein execution of the instructions to determine the actual IBO value causes the first wireless device to:
estimate the actual IBO value based on an IBO value associated with a null data packet (NDP) containing one or more training symbols transmitted by the second wireless device, an estimated output power back-off (OBO) value of the NDP, and an estimated OBO value of the wireless signal.

17. The first wireless device of claim 10, wherein execution of the instructions to negotiate the set of IBO values causes the first wireless device to:
transmit, to the second wireless device, a request including a first proposed set of IBO values;
receive, from the second wireless device, a reply including a second proposed set of IBO values; and
determine the negotiated set of IBO values based on a combination of the first and second proposed sets of IBO values.

18. The first wireless device of claim 17, wherein the second proposed set of IBO values is based on a range of receiver-tolerable error vector magnitudes (EVMs).

19. A non-transitory computer-readable storage medium comprising instructions that, when executed by one or more processors of a first wireless device, cause the first wireless device to determine input power backoff (IBO) values used for wireless transmissions by a second wireless device by performing operations comprising:
negotiating a set of IBO values that are mutually compatible to each of the first and second wireless devices;
receiving a wireless signal from the second wireless device; and
determining an actual IBO value used by the second wireless device to transmit the wireless signal based at least in part on the negotiated set of IBO values.

20. The non-transitory computer-readable storage medium of claim 19, wherein the set of IBO values is negotiated during at least one of an association operation, a negotiation operation, or an exchange of proposed sets of IBO values between the first and second wireless devices.

21. The non-transitory computer-readable storage medium of claim 19, wherein execution of the instructions causes the first wireless device to perform operations further comprising:
receiving an indication of a change in the negotiated set of IBO values from the second wireless device; and
updating the negotiated set of IBO values stored in the first wireless device based on the received indication.

22. The non-transitory computer-readable storage medium of claim 19, wherein execution of the instructions to determine the actual IBO value causes the first wireless device to perform operations further comprising:
receiving a message, from the second wireless device, indicating the actual IBO value.

23. The non-transitory computer-readable storage medium of claim 19, wherein execution of the instructions to determine the actual IBO value causes the first wireless device to perform operations further comprising:
estimating the actual IBO value based on one or more of an indicated IBO value, the negotiated set of IBO values, and an output power backoff (OBO) value associated with transmission of the wireless signal.

24. The non-transitory computer-readable storage medium of claim 19, wherein execution of the instructions to determine the actual IBO value causes the first wireless device to perform operations further comprising:
estimating the actual IBO value based on one or more of digital pre-distortion (DPD) settings of the second wireless device, power amplifier (PA) settings of the second wireless device, and an estimated output power backoff (OBO) value of the wireless signal.

25. The non-transitory computer-readable storage medium of claim 19, wherein execution of the instructions to determine the actual IBO value causes the first wireless device to perform operations further comprising:
estimating the actual IBO value based on an IBO value associated with a null data packet (NDP) containing one or more training symbols transmitted by the second wireless device, an estimated output power back-off (OBO) value of the NDP, and an estimated OBO value of the wireless signal.

26. The non-transitory computer-readable storage medium of claim 19, wherein execution of the instructions to negotiate the set of IBO values causes the first wireless device to perform operations further comprising:
transmitting, to the second wireless device, a request including a first proposed set of IBO values;
receiving, from the second wireless device, a reply including a second proposed set of IBO values; and
determining the negotiated set of IBO values based on a combination of the first and second proposed set of IBO values.

27. The non-transitory computer-readable storage medium of claim 26, wherein the second proposed set of IBO values is based on a range of receiver-tolerable error vector magnitudes (EVMs).

28. An apparatus for determining input power backoff (IBO) values used for wireless transmissions with a wireless device, the apparatus comprising:
means for negotiating a set of IBO values that are mutually compatible to each of the apparatus and the wireless device;
means for receiving a wireless signal from the wireless device; and
means for determining an actual IBO value used by the wireless device to transmit the wireless signal based at least in part on the negotiated set of IBO values.

29. The apparatus of claim 28, wherein the set of IBO values is negotiated during at least one of an association operation, a negotiation operation, or an exchange of proposed sets of IBO values between the apparatus and the second wireless device.

30. The apparatus of claim 28, further comprising:
means for receiving an indication of a change in the negotiated set of IBO values from the wireless device; and
means for updating the negotiated set of IBO values stored in the apparatus based on the received indication.
